(19) United States
(12) Patent Application Publication
(10) Pub. No.: US 2005/0143198 A1
(43) Pub. Date: Jun. 30, 2005

(54) Predictive analysis system and method

(76) Inventor: Anthony Charge, Wanniassa Hills (AU)

Correspondence Address: William L. Warren;SUTHERLAND ASBILL & BRENNAN LLP, 999 Peachtree Street, NE, Atlanta, GA, 30309-3996, US

(21) Appl. No.: 11/024,009

(22) Filed: Dec. 28, 2004

Related U.S. Application Data
(63) Continuation-in-part of application No. PCT/AU03/00831, filed on Jun. 30, 2003.

(30) Foreign Application Priority Data
Jun. 28, 2002 (AU) PS 3255

(51) Int. Cl. A63F 13/00

(52) U.S. Cl. 473/422

(57) ABSTRACT

A method of coaching a sporting team or individual participants during a sporting event is disclosed which includes generating quantitative data 11 relating to performance in previous sporting events, generating quantitative data 12 relating to performance during the sporting event, generating qualitative data 13,14 relating to the sporting event and to the participants therein, and analysing the generated quantitative and qualitative data in a computer controlled system in accordance with a program 20 which includes a risk management methodology 21 to thereby generate an output 30 of predicted strategic significance in the future conduct of the sporting event.

### TECHNICAL FIELD

This invention relates to a predictive analysis system and method.

The invention has particular but not exclusive application to such a system and method when applied to sports coaching and particularly the coaching of a sporting team or individual.

In a preferred aspect of the invention it will be seen that real-time performance and predictive reports, risk assessments and recommendations are produced which relate to the performance of a sporting team in an actual sporting event. These are prepared by a scientific risk management-based analytical, statistical and predictive system which records and analyses data and information about and from sporting events.

### BACKGROUND OF INVENTION

It is known to statistically analyse sporting events and performances, whether by a team or by an individual. Quantitative statistical systems are known and are continually being enhanced.

### SUMMARY OF INVENTION

The present invention aims to provide an alternative to known methods and systems of the above type.

This invention in one aspect resides broadly in a method of coaching a sporting team or individual participants during a sporting event, the method including:—
generating quantitative data relating to performance in previous sporting events;
generating quantitative data relating to performance during the sporting event;
generating qualitative data relating to the sporting event and to the participants therein, and
analysing the generated quantitative and qualitative data in a computer controlled system in accordance with a program which includes a risk management methodology to thereby generate an output of predicted strategic significance in the future conduct of the sporting event.

As used herein the expression “quantitative data relating to performance in a sporting event” is to be given a broad meaning and includes data relating to measurable parameters and indicators of individual and team performance.

As used herein the expression qualitative data relating to performance in a sporting event” is to be given a broad meaning and includes data relating to intangible aspects relating to the sporting event and to participants therein, both prior to and during the event and relating to both the team and individual players. Examples of these intangible aspects include cultural characteristics, mental aspects, environmental factors and psychological impacts and insights.

It is preferred that the analysis of the qualitative data includes regression analysis techniques.

One output of predicted strategic significance can include prediction of a break point in the sporting event.

As used herein the expression “break point in a sporting event” refers to a stage in the sporting event beyond which, if the conduct of play were to continue in the existing pattern, it is highly likely that one team or individual will win the event or a discrete component of the event. The expression “discrete component” of an event refers to components such as a game or a set in a tennis match, a quarter or a half in a football match, an innings in a baseball match etc.

Another output of predicted strategic significance can be an indication of the dominance over the other by one team or individual in the sporting event. It is preferred that the indication of dominance includes a progressive time based graphical indication above or below a median line, the position above or below the line being indicative of the dominance over the other by one team or individual in the sporting event.

Another output of predicted strategic significance can include assessment reports of past and future performance of teams and/or individuals in the sporting event.

Another output of predicted strategic significance can include adaptive control indicators. It is preferred that the adaptive control indicators include suggestions for remedial action and/or advice regarding opportunities and/or strategies for offensive and/or defensive moves.

In another aspect this invention resides broadly in a system for coaching a sporting team during a sporting event, the system including:—
at least one input device and a database to generate quantitative data relating to performance in previous sporting events;
at least one input device and a database to generate quantitative data relating to performance during the sporting event;
at least one input device and a database to generate qualitative data relating to the sporting event, and
a computer including a computer program to analyse the generated quantitative and qualitative data by a risk management methodology to thereby generate an output of predicted strategic significance in the future conduct of the sporting event.

### DESCRIPTION OF DRAWINGS

In order that this invention may be more easily understood and put into practical effect, reference will now be made to the accompanying drawings which illustrate a preferred embodiment of the invention, wherein:—

FIG. 1 is a schematic diagram illustrating the method of the present invention;

FIG. 2 illustrates the graphical output of a so-called Controlometer, and

FIG. 3 is a schematic block diagram illustrating the system of the present invention.

### DESCRIPTION OF PREFERRED EMBODIMENT OF INVENTION

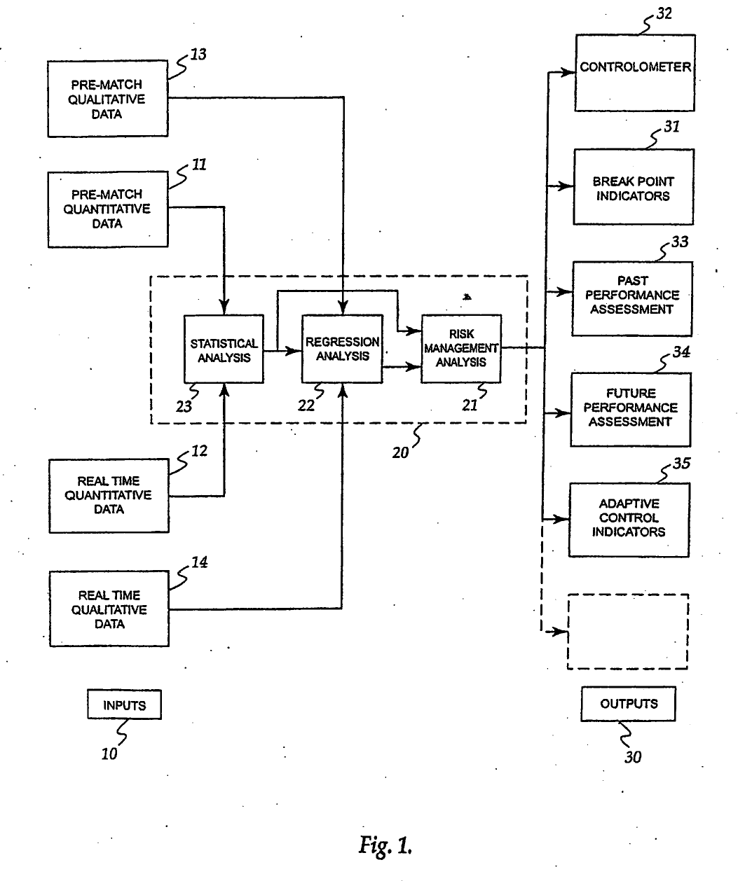

As can be seen in FIG. 1 which illustrates a method of coaching a sporting team or individual participants during a sporting event, a series of data inputs 10 is generated. Quantitative data 11 is generated which relates to performance in previous sporting events; quantitative data 12 is generated which relates to performance during the sporting event, and qualitative data 13,14 is generated which relates to the sporting event and to the participants therein. The generated quantitative and qualitative data 11, 12 and 13,14 is analysed in a computer controlled system in accordance with a program 20 which includes a risk management methodology 21 to thereby generate outputs 30 of predicted strategic significance in the future conduct of the sporting event.

The qualitative data may be data 13 relating to past sporting events or to the participants therein, or it may be data 14 relating to the current sporting events or to the participants therein.

The quantitative data 11,12 is subjected to statistical analysis 23 and both it and the qualitative data are subjected to regression analysis 22.

Looked at in another way, both qualitative and quantitative pre-match data can be regarded as historical and relates to past performance. As will be seen with more specific reference to the preferred embodiment described subsequently in more detail, this historical or pre-match data can be regarded as having a relationship value which is established from the history of games between any two clubs who are to compete in a sporting event.

Similarly what can be termed real-time data, both qualitative and quantitative, is current and relates to the immediate lead up to the sporting event and to the actual performance during the sporting event. Again, as will be seen with more specific reference to the preferred embodiment described subsequently in more detail, this real-time data can be regarded as having a “lead-in to the game” value which is established during the period between consecutive games which a team plays during the competition. This “lead-in to the game” value is based on team comparisons and form, taking into account mental, physical and environment factors.

A number of outputs 30 of predicted strategic significance in the future conduct of the sporting event are provided. These include the indication 31 of a break point in the sporting event. A break point is a time or a stage during a sporting event beyond which, if the conduct of play were to continue in the existing pattern, it is highly likely that one team or individual will win the event or a discrete component of the event, for example a game or a set in a tennis match, a quarter or a half in a football match, an innings in a baseball match etc.

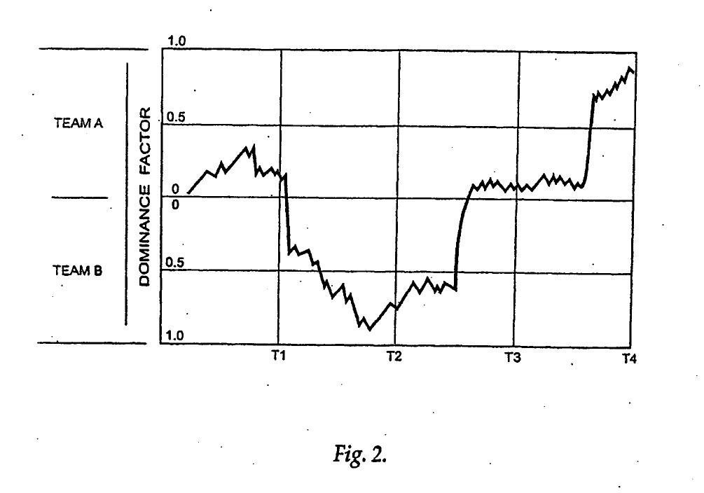

Another output of predicted strategic significance is an indication 32 of the dominance over the other of one team or individual in the sporting event. This is seen in more detail in FIG. 2 wherein the indication is seen as a progressive time based line which is traced above or below a median line, the position above or below the line being indicative of the progressive relative dominance of one team or participant over the other.

Other outputs of predicted strategic significance include assessment reports 33 and 34 of past and future performance respectively of teams and/or individuals in the sporting event.

Another output of predicted strategic significance is an adaptive control indicator 35 which can include for example, suggestions for remedial action and/or advice regarding opportunities and/or strategies for offensive and/or defensive moves.

Other outputs of predicted strategic significance can be categorised as key performance measures and telling factors.

The intangible and qualitative components and the reports and recommendations based thereon are enhanced and hence are more useful with real-time match statistics being incorporated into operation of the system.

In the following description of general operation of the system, reference will be made by way of illustrative example, to a sporting event in the nature of the game of Australian football.

The intangible pre-match parameters or indicators include psychological lead-up to the game, physical and environmental factors, shock news and events, the M-factor (motivational issues), switch-ons, what is at stake and who has come to play. Together with pre-match statistics these pre-match events overlay and take precedence over past match statistics.

The intangible and qualitative components are converted to mathematical formulae and incorporated into an IT software system. The software is used in line with traditional match statistical information in two forms—historical statistical information stored on hard disk before a game starts and secondly, progressive match statistical data fed live into the system. Input may be by conventional keyboard means for example, by voice activated control systems, or by GPS or other automated positional real-time analysis of the game play. Voice activated input is particularly suitable for inputting real-time intangible parameters.

Reports are triggered when a match reaches a defined break-point—which can be at anytime in the match. Assessment reports are also available for a quarter, half or full game—and as above are based on a combination of qualitative analysis, quantitative data and a so-called game “controlometer” to be described subsequently.

Such reports are effective to warn a coach that a break-point has been reached and unless a change occurs, the current pattern or trend of play will cause the team to lose the quarter, half, match, etc. Conversely, they warn that the opposition team is going to win the quarter etc unless a change occurs. Reports on break-point for the opposition can also be generated thereby allowing a ready reconciliation with the ‘controlometer.’

The controlometer reads the game and records who is controlling the agenda of the game. As seen in FIG. 2, a pointer or trace moves above and below a line for either team and produces signals when one team reaches certain points—eg sustained scoring pressure in the danger zone and vulnerability through certain events such as turnovers, missed scoring opportunities etc.

The controlometer ‘reads’ the game and has the potential to measure performance responses to changes in tactics, game plan moves, player rotations, etc. The output from this display constitutes a mathematical input to the system as an ‘agenda’ factor and secondly a visual aid to coaches as the controlometer is used and shows an agenda change from one team to the other.

It will be clear that the system and method of the present invention, by providing the improved analysis which enables these break points to be predicted in advance, complements the intuition of even the best coaches and allows the coaches to send early instructions to the players to enhance the team's fortunes at the predicted break points.

As well as historical data which provides useful planning information for the coach and a system guide for interpreting patterns in a current game, the best available current match statistics are input in real time into the software system during the game. Such input includes known statistics such as number of kicks, attacks into 50 m zone etc. In addition it includes information such as
Ratio of scoring opportunities to scores;
Individual player performance—number of players winning their positions—weighted for player ratings;
Location and duration of play at points on the field—weighted for value;
Patterns of play—direct and indirect;
+Changes—weighted;
Source of scoring—turnover, ball-up, throw-in, free-kick etc;
Weighting for overall first quarter differential between teams;
Performance statistics—who and how the ball is won, possession time weighted for distance forward, sequential possessions—weighted for distance forward, scoring success/failure ratio, number of possessions per goal (higher the number higher the risk of failure), number of players to goal, flooding indicator, launch of scoring—defence or midfield, 50 m entry/scoring ratio; and
Quarter score differentials—eg third quarter score equals opponents second quarter score.

This statistical quantitative real time match performance data is combined with the intangible qualitative components.

During a game certain events occur which have a psychological impact on the teams and individual players and which can affect the outcome of a quarter or the whole game. These events can even contradict the flow of a game as recorded statistically and therefore their analysis adds a definite discrete value-added factor to statistics.

Such factors include the following which are by no means exhaustive:—
Domination of play
Scoring against the flow of play
Team or ratio of players running hot
Demoralising incident or scoring
Tactical change—player or game plan
Injuries to key players or resulting in team imbalance
Pattern of turnovers under pressure resulting in scores
Reporting of players
Players or teams losing control—eg 50 m penalties and being disciplined
Pattern of missing goals for behinds or out of bounds
Benching of stars
Key players with poor performances
Handballing consistency over quarters
Pattern of top 6/middle 6/bottom 6 performances

A primary output from the system (apart from observation of the controlometer and mental intuition from inputting information) is the indication of so-called “break points” for each quarter or for the entire match. A warning is generated at a point when—if things remain constant—the team is at risk of losing the quarter/game. This indication is accumulative and is determined from combined analysis of tangible and intangible data loaded before and during the game.

These break point warnings add to the coaches' professional intuition in a manner which can be likened to having a “super coach” looking over their shoulder.

One performance measure is the break-point showing for the other coach (which that coach will not see)—indicating that the game plan of the coach utilising the present invention is working.

When a warning is generated the system indicates the key aspects of the tangible and intangible indicators which triggered the warning. This will help the coach translate his ‘inkling’—which may come to him quite intuitively and without rationale—into an analysis of the area(s) where the team or game plan is breaking down. The system thus produces advice to the coach where attention or change is needed, which advice or warning the coach is obviously free to accept or reject.

Such warnings provide anticipatory advice to coaches about areas of performance, or players, or match plays which opposing coaches may be exploiting (or beginning to exploit) or where they are gaining (or beginning to gain) an advantage.

The incorporation of risk management scenario planning techniques into the software facilitates the real time inputting of opposition moves and player changes and facilitates the prediction of impacts.

Looking now in more detail at the present invention in the context of the preferred embodiment of a particular game of Australian football between two teams, the key areas of the system and their interrelationships are as follows:—

1 Relationship Value. This refers to inputs established from the history of games between any two clubs
(a) Quantitative Component
   (i) Statistical Probability of winning based on analysis of historical match data
(b) Qualitative Component
   (i) Domination Factor=measured from head to head history of the two clubs—results over last 10 years and last 3 years (weighted)
   (ii) Special Match Factor=measured from history of a particular game or particular game between two clubs—eg event/day, location, comparative team structure or game style

A generic algorithm representing this aspect of the method and system of the invention is
RV=f[SP:DF:SMF]
where
   RV is Relationship Value
   SP is Statistical Probability
   DF is Domination Factor
   SPM is Special Match Factor

In other words, Relationship Value is a function of Statistical Probability, Domination Factor and Special Match Factor.

2 Lead in to Game Value. This refers to inputs established during the week between games based on team comparisons and form, taking into account mental, physical and environment factors
(a) Quantitative Component
   (i) Team Value Factor—a weighted combination of:
      Closeness to preferred or best team available
      Closeness to team that played over the last two weeks
      Best six available
      Second best six available
      Value of interchange bench
      Discount for players carrying injuries/return from long absence
      Predicted win/loss on all match-ups
(b) Qualitative Component
   (i) Mindset Value Factor—a weighted combination of:
      Take-out factor from last game—eg positive, increased pressure
      Take-in factor to game—expected relationship at first bounce
      Vulnerability factor—risk of anti-climax or emotional relief/crash
      Switch factor—closure, when and how effective
      Team focus factor—looking forward or just next game
      Significant individual focus factor—eg goal, motivation
      Media factor—eg last game, switch, special match value, distract
      Team pressure value—eg position, 8 points, top eight berth
      Individual game pressure—retain spot, critical opponent
      Confidence factor—atmosphere, intangibles
      Coping factor—player resilience threshhold
      Intensity factor—absence/presence—positive or negative
      Player feeling factor—average and variation from normal
      Game plan belief factor—understanding and achievability
      Risk assessment of game plan—likelihood, consequences
      Motivation factor—extent to which team requires motivation
      Internal shock, crisis, distraction factor during week
      Risk of carrying shock, crisis, distraction into match
      Form rating factor—assessment of form to be carried into game
      Impact of normal pre-match mental ‘warm-up’
   (ii) Physical Value Factor—a weighted combination of:
      Critical player presence/absence—timing impact relevant
      Players carrying injuries
      Match fitness of key players
      Leadership presence
      Weather factor—rain, wind
      Venue factor—physical and mental
      Ground conditions—style, team suit/adjusted
      Value of physical warm-up expected
   (iii) Environment Factor—a weighted combination of:
      Home ground advantage
      Climatic advantage
      Time of play advantage
      Home crowd advantage
      Travel effect—normal coping factor/extent of recent travel
      Relationships factor—critical individual risk—carry-in factor
      Personal crisis factor—critical individual risk—carry-in factor
      Public issue or crisis factor—team/individual—carry-in factor

A generic algorithm representing this aspect of the method and system of the invention is
LGV=f[TVF:MVF:PVF:EF]
where
   LGV is Lead-in Game Value
   TVF is Team Value Factor
   MVF is Mindset Value Factor
   PVF is Physical Value Factor
   EF is Environment Factor

In other words, Lead-in Game Value is a function of Team Value Factor, Mindset Value Factor, Physical Value Factor and Environment Factor.

3) Game Agenda—‘Controlometer’. This output is established by plotting the flow of the agenda of the game and producing warnings and triggers at key points.

(a) Quantitative Component
   (i) Agenda Control Factor is measured from the following:
      recording possession, entering 50 m and scoring
      minor possession aberrations are ignored
      maximum point reached when team goals
      key alerts are generated in the following circumstances:
         when possession leads to scoring opportunity (attack)+
         when possession inside 50 m does not result in a goal or score after x seconds (defence)+
         when turnover leads to successful disposal (change)
         when turnover leads to goal/score (vulnerability)
(b) Qualitative Component
   (i) Validation Factor. This enables coach to reconcile game plan against performance and measure variations by examining for example:
      change of game control
      comparative possession
      agenda control and conversion rate
      domination of midfield, attack and defence cost of turnovers effect on agenda control

A generic algorithm representing this aspect of the method and system of the invention is
GA(C)=f[ACF:VF]
where
   GA(C) is Game Agenda—“Controlometer”
   ACF is Agenda Control Factor
   VF is Validation Factor

In other words, Game Agenda—“Controlometer” is a function of Agenda Control Factor and Validation Factor.

4) Key Performance Measures. These are measured by team performance outputs derived from match activities.

(a) Quantitative Components
   (i) Team Performance Factor which is a function of [MindseV Intensity/Fitness and Skill/Game Plan/Winning Possession/into 50 m Zone/Scoring]. It is measured from analyzing match statistics into the following performance criteria:
      Midfield dominance quotient
      Effective disposal quotient
      Winning top six player quotient
      Winning second top six player quotient
      Winning third top player quotient
      Clearances from stoppages
      Continuing bench value quotient
      Overall winning position quotient—(all 18 positions)
      Goals from entries into 50 m zone
      Player domination by team—top 12 players by effectiveness
      Patterns of play producing goals
      First quarter barometer reading on comparative effectiveness
      Source of goals—attack, midfielders, defenders, bench
      Winning contested possession
      Comparative time in possession
      Comparative number of disposals to goal
      Average time taken to advance 50 m
      Proportion of players without a possession/disposal in last 10 minutes
      Time in 50 m zone/goals scored
(b) Qualitative Components
   (i) Game plan effectiveness. This is measured by assessment of achieving its overall objectives eg shutting down opposition scoring capacity and on particular aspects including:
      Start of game relationship validation
      Team switched on to play
      Anticipation of opposition game plan
      Effectiveness of changes to game plan
      Maintenance of team intensity
      Pressure on opposition
      Adjustment effectiveness—stoppages, turnovers, switches, etc
      Pattern predictability applicable
      Crowd influence as expected
      Umpiring factor relevant
      Spine and centre control
      Mode reaction time—attack, defence or dispute
      Goalkickers fit pattern of game plan
      Matchup effectiveness
      Progressive Mindset, Physical and Environment Factor influence
      Scoring ease (comparative)
         ease of entry to scoring zone
         number of entries to scoring zone
         goals from marks
         goals from play disposals per goal

A generic algorithm representing this aspect of the method and system of the invention is
KPM=f[TPF:GPE]
where
   KPM is Key Performance Measure
   TPF is Team Performance Factor
   GPE is Game Plan Effectiveness

In other words, Key Performance Measure is a function of Team Performance Factor and Game Plan Effectiveness.

5) Telling Factors. These are significant or critical factors which can influence the outcome.

(a) Quantitative Components
   (i) Projection of progressive Team Performance Factor results
      (ii) Scoring pattern against the flow of possession
      (iii) Maintenance of player domination for a defined time period
      (iv) Repeated turnovers resulting in goals
      (v) Comparative scoring ratios—into 50 m/goals
      (vi) Effective disposal pattern projection
      (vii) Comparative weighted performance of top six players
(b) Qualitative Components
   (i) Agenda Controlometer predictions
   (ii) Loss of discipline—behavioural change
   (iii) Demoralising incidents
   (iv) Loss of intensity
   (v) Leadership inspiration
   (vi) Heroic incident
   (vii) Key player injury loss
   (viii) Key players benched for poor form
   (ix) Reports
   (x) Game plan changes forced by opposition
   (xi) Match-up changes forced by opposition
   (xii) Significant take-out mindset value from a quarter
      6) Breakpoints. These are points at which if game continues as is, the system predicts a quarter/game win/loss
(a) Quantitative Component
   (i) Controlometer prediction for quarter/game
   (ii) Aggregate Team Performance factor exceeds say 60%
   (iii) Controlometer warnings from progressive triggers, viz:
      comparative scoring zone entry and conversion
      comparative scoring zone entry and not scoring
      turnovers resulting in scores
      midfield dominance
      domination factor exceeds 60%
      comparative possession
      scoring pattern against the flow
      significant increase in uncontested possessions
(b) Qualitative Component
   (i) Proportion of agenda control reaches 60%
   (k) Refusal to chase opposition (k) Second and third effort quotient
   (l) 1% quotient
   (m) Degree of difficulty in scoring
   (n) Observable kinesics and proxemics
      7 Change Indicators
      The system will thus be seen to produce the following outputs and outcomes:
Controlometer=patterns, triggers and warnings: validation point for coaching;
Aggregate Team Performance Factor=determined progressively through the game
Performance outputs=derived from realtime analysis of match statistics
Breakpoint areas=identified from controlometer and performance analysis+
Capacity to program for information on demand=analysis of play/player
Capacity to scenario plan—with attached risk assessment+
Capacity to anticipate possible opposition plans/moves

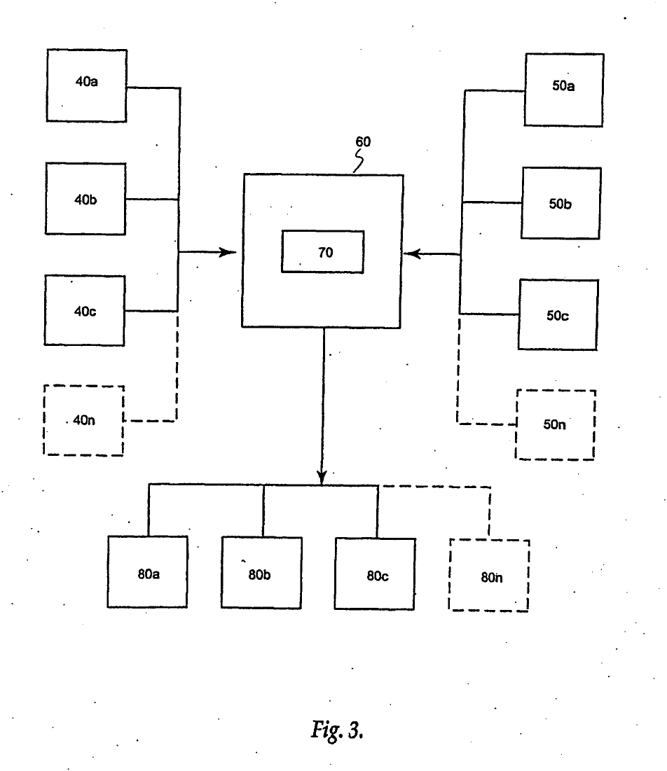

Turning now to FIG. 3 which is a block diagram schematically illustrating the system of the present invention for coaching a sporting team during a sporting event, the system is seen to include input devices and database 40a, 40b, 40c . . . 40n for generating data relating to performance in previous sporting events, and input devices and database 50a, 50b, 50c . . . 50n for generating data relating to performance during the sporting event. A computer 60 including a program 70 analyses the generated quantitative and qualitative data by a risk management methodology to thereby generate outputs 80a, 80b, 80c . . . 80n of predicted strategic significance in the future conduct of the sporting event.

The data generated by input devices and database 40a, 40b, 40c . . . 40n relates to performance in previous sporting events. The data generated by input devices and database 50a, 50b, 50c . . . 50n relates to performance during the sporting event and may be either quantitative data as defined above or qualitative data as defined above.

Accordingly input devices and database 40a, 40b, 40c . . . 40n can variously comprise access to statistical databases of historical data, and input devices such as keyboards, palm pilots and the like for accessing further information or for inputting further information into computer 60.

Similarly, input devices and database 50a, 50b, 50c . . . 50n can variously comprise manual input devices such as keyboards, palm pilots, voice/responsive actuators and the like for inputting information regarding progress of the game into computer 60, or remote/automatic input devices such as GPS based devices for inputting positional information regarding the game into computer 60.

Program 70 controls computer 60 in the manner described above to generate a series of outputs 80a, 80b, 80c . . . 80n of predicted strategic significance in the future conduct of the sporting event. These outputs variously comprise the outputs described above and can variously be provided by suitable peripheral equipment such as palm pilots, computer screens, print outs, audible alarms or warnings such as artificial voice systems.

It will be appreciated that the present invention has a number of advantages when compared with existing methods and systems for coaching a sporting team or individuals during a sporting event.

Whereas existing systems are based on tangible events and incidents, and measured in quantitative terms based solely on statistics (eg match details), analysis and probability calculations, the present invention will be seen to include intangible aspects of games—preparatory to and during a match—measured through a combination of qualitative and quantitative assessments—and is based on risk management methodologies.

The present invention also is seen in a preferred embodiment to incorporate, inter alia, qualitative regression analysis techniques projected forwards—and identifies ‘break points’ in anticipation. It can be said to replicate the mind, the intellect of a “super-coach”, and derives an absolute match analyses at a level arguably above the mental capacity of the coach, and does this at the time of occurrence rather than post-match.

The outcome reports produced during a game by the present invention attempt to replicate what the hypothetical super-coach could in theory identify, analyse and predict.

Whilst theoretically, and most probably also in practice, a top coach will have an inkling of ‘unrest’ at break points during a game, it remains the fact that even the very best coaches lose games and can look back and realize that if they had adopted a particular strategy or game play at a particular point, they might have saved the match. This present system provides coaches with such a regression analysis in realtime.

It will be appreciated that the system can also be used to predict competitions as well as individual games—and thus is suitable for use in betting on sporting events or competitions.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. A method of coaching a sporting team or individual participants during a sporting event, the method including:—
generating quantitative data relating to performance in previous sporting events;
generating quantitative data relating to performance during the sporting event;
generating qualitative data relating to the sporting event, and
analysing the generated quantitative and qualitative data in a computer controlled system in accordance with a program which includes a risk management methodology to thereby generate an output of predicted strategic significance in the future conduct of the sporting event.

2. A method of coaching as claimed in claim 1, wherein the analysis of the qualitative data includes regression analysis techniques.

3. A method of coaching as claimed in claim 1, wherein an output of predicted strategic significance includes prediction of a break point in the sporting event.

4. A method of coaching as claimed in claim 3, wherein an output of predicted strategic significance includes an indication of the dominance over the other by one team or individual in the sporting event.

5. A method of coaching as claimed in claim 4, wherein the indication of dominance includes a progressive time based graphical indication above or below a median line, the position above or below the line being indicative of the dominance over the other by one team or individual in the sporting event.

6. A method of coaching as claimed in claim 1, wherein an output of predicted strategic significance includes assessment reports of past and future performance of teams and/or individuals in the sporting event.

7. A method of coaching as claimed in claim 1, wherein an output of predicted strategic significance includes adaptive control indicators.

8. A method of coaching as claimed in claim 7, wherein the adaptive control indicators include suggestions for remedial action and/or advice regarding opportunities and/or strategies for offensive and/or defensive moves.

9. A system for coaching a sporting team or individual participants during a sporting event, the system including:—
at least one input device and a database to generate quantitative data relating to performance in previous sporting events;
at least one input device and a database to generate quantitative data relating to performance during the sporting event;
at least one input device and a database to generate qualitative data relating to the sporting event, and
a computer including a computer program to analyse the generated quantitative and qualitative data by a risk management methodology to thereby generate an output of predicted strategic significance in the future conduct of the sporting event.
